(19) United States
(12) Patent Application Publication
(10) Pub. No.: US 2002/0073143 A1
(43) Pub. Date: Jun. 13, 2002

(54) File archive and media transfer system with user notification

(76) Inventors: Eric D. Edwards, San Francisco, CA (US); Clay H. Fisher, Belmont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/932,038

(22) Filed: Aug. 16, 2001

Related U.S. Application Data
(60) Provisional application No. 60/229,652, filed on Aug. 31, 2000.

(51) Int. Cl. G06F 15/16

(52) U.S. Cl. 709/203; 709/219

(57) ABSTRACT

A computerized method, that includes receiving from a first device, across one or more networks, one or more files to a storage location; and providing file transfer notification to a second device, across the one or more networks.

### RELATED APPLICATIONS

This application claims the benefit of U.S. Provisional Application No. 60/229,652, filed Aug. 31, 2000.

### FIELD OF THE INVENTION

This invention relates generally to computers, and more particularly to a system for a server to archive files transferred from a device and to provide copies of selected archived files on a different media.

### COPYRIGHT NOTICE/PERMISSION

A portion of the disclosure of this patent document may contain material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 1999, Sony Electronics, Inc., All Rights Reserved.

### BACKGROUND OF THE INVENTION

Presentation software exists that allows a computer to display one or more graphical files such as photographs, illustrations, or drawings. Such presentation software may reside on a user's computer or on a server networked to the user. In addition, software in HTML format exists where one or files can be displayed on one or more web pages at a web site. The reproduction of physical or paper copies of selected graphical files is accomplished through the presentation viewing software, through the operating system file manager, or through HTML commands that send a “print” command to a printer such as an ink jet color printer. Music can be downloaded over the Internet and transferred to music players existing on a computer. In addition, computer software and hardware exist to transfer music files onto a CD. However, as digital image resolution improves, the size of each picture file increases and is currently to a point where a small number of high resolution pictures can take up significant space on an individual's storage medium. In addition, convenient access to high resolution printers to produce hard copies of these images is not currently available.

### SUMMARY OF THE INVENTION

A file archive and media transfer system with user notification is disclosed that maintains an archive copy of user files in an account at a data storage location such as a web server, and provides for the generation of one or more physical copies (e.g. a print and/or a CD) of one or more files selected from the archive that can be sent by mail or courier to an address. A method is described that allows a server such as a web server to set up an account for a user and with that account, the web server can change the format of one or more files such as from MP3 to Wave. The server can receive or send one or more files that can be in a graphical and/or audio format, can generate a request for a physical copy of a file to be made and sent to a destination, can send notice of successful transfer of the one or more files through a file transfer notification process, can send notification of a mailing status of the files transferred to the new media, can provide for a presentation of current accounting information to a user. The server can accept instructions from a device over one or more networks that include PSTN, a LAN, a WAN, or the Internet.

Shipment of the files in the new media may be by standard postal methods such as U.S. Mail, UPS, FedEx, etc. Finally, tracking status can be provided the user for each shipment and charges can be applied to the account for the services rendered.

The present invention describes systems, users, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of one embodiment of an apparatus and method for a file archive and media transfer system with user notification.

FIG. 2 is a flow diagram of one embodiment of a method for a file archive and media transfer system with user notification.

FIG. 3 is an illustration of one embodiment of a device connected to a server.

FIG. 4a is an illustration of a client interacting with the server.

FIG. 4b is a block diagram of processing elements of a typical computer.

### DETAILED DESCRIPTION OF THE INVENTION

In the following detailed description of embodiments of the invention, reference is made to the accompanying illustrations in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

A system is described where, after accepting instructions or requests from a device, a server can accomplish a variety of tasks within a user account on the server. Initially, the server can create the user account and then, or anytime later, transfer one or more files from the device for storage into archive at the server or at a location remote from the server. The device may be non-Internet enabled such as a telephone, telephony-enabled PDA (personal digital assistant), or a cell phone. The device may also be an Internet enabled device such as a computer connected to one or more networks such as the Internet, a WAN, LAN, etc. The computer may be in any form such as a stand-alone, a laptop, or an Internet-enabled PDA.

The server can accept instructions (requests) for accepting new files into the account archive (account). The server can allow for a selection of one or more files in archive and once selected, the server can accept instructions to transfer these files to another account, delete the files, or copy the files onto another media. File transfer to the remote location can also be accomplished over one or more of the networks such as PSTN, WAN, LAN, etc. After the server has completed one or more requests, the server can send a notification to a first device that generated the requests or to a designated second device. The notification may be that the instructions to the server have been accomplished, partly accomplished, or have failed entirely. More than one notification may be generated by the server such as where multiple requests have been made and as each request is completed, a notification regarding that request can be sent. In the case where a request is taking longer than a default time to accomplish, the multiple notifications may simply provide (over designated intervals) information that the request is still pending. In addition, the multiple notifications may be sent over different networks and to one or more devices. In this manner, the server may be designated to send more urgent notifications, such as a successful file download (or unsuccessful file download), to a cell phone while completion of media transfer notification may be sent to a home computer over the Internet such, as for example, using e-mail or short messaging.

Receipt of notification can be accomplished with less sophisticated devices that are non-Internet enabled and/or non-interactive such as a pager or with automated voicing to a basic telephone. In some cases, a mail service may provide notification, such as with the U.S. Mail system, Federal Express, or UPS. An explanation for a cause of a partial or complete failure of a request can be provided with the notification, such as in the form of an error code.

The media transfer request can include copying of the selected files onto one or more different media types. In the case of graphical files, the request may be that the files be processed into prints or onto a storage media such as a CD. When choosing a print option, software may reside at the device (e.g. a photo kiosk) or at the server (e.g. an Image Station) that can allow photo management such as cropping of any selected image file so that only the area cropped will be printed. The photo management software may accept a request for black and white or sepia prints from black and white or from color files and may be able to set the level of resolution desired for each print. There can be default settings in the account such as to print to the maximum resolution of the file or with a white border, etc. and the server may allow changes to the default settings for one time only or permanently.

Copies placed on a different medium (media transfer) can be produced and the copies shipped by a carrier of the user's choosing, to an address designated by the user. Media transfer notification data can be provided the user automatically through the device or a device that is less interactive, i.e. receive limited data only. The media transfer notification data could include any level of information such as that a print request # XXX has arrived in St. Louis (heading for New York), or that CD's ordered Jan. 1, 2001 were shipped on Jan. 4, 2001. In addition, transaction numbers could be assigned for such events as successful files downloaded to the server, dates as to when media transfers were shipped, or mail tracking data. Alternatively, media transfer notification data could be provided by the server, when queried by the device, once the account has been accessed.

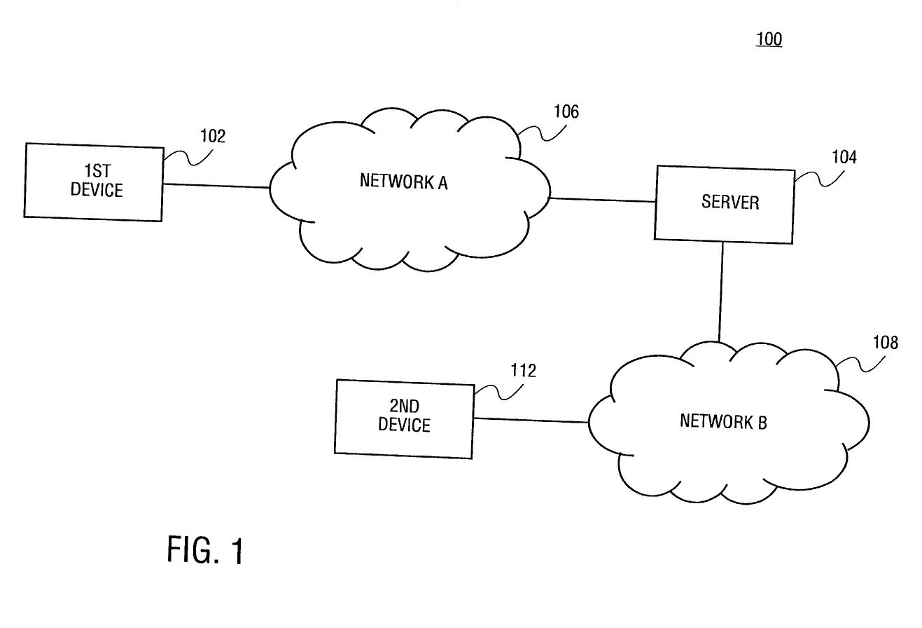

FIG. 1 is a block diagram of one embodiment of a file archive and media transfer system with user notification 100. An interactive device 102 can access a server 104 through network A 106 such as the public switched telephone network (PSTN), the Internet, a local area network (LAN), or a wide area network (WAN). The interactive device 102 may be a public terminal in the form of an ATM, a photo kiosk, a computer located at a cyber cafe, a specially adapted telephone, etc. Telephones operating at higher frequencies, such as above 2 GHz can be efficient at transferring such files. In one embodiment, the device 102 is a computer that can connect to server 104 directly through network A 108 using a modem or with a high-speed Internet access system such as DSL.

Once the connection is made, server 104 can interact with the device 102 to generate one or more requests. When the requests are completed, server 104 sends a service notification via network A 106 to device 102 or via network 106 to second device 112. The server notification notifies the user of the completion of an event related to one or more of the operations performed by the server 104. Second device 112 may be, for example, a pager, a facsimile machine, a telephone, a cell phone, an answering machine, a computer, a public kiosk, or any device that can receive information over network B 108. Network B 108 may be, for example, a public switched telephone network (PSTN), wide area network (WAN), local area network (LAN), or the like. In one embodiment, second device 112 is a non-Internet enabled device.

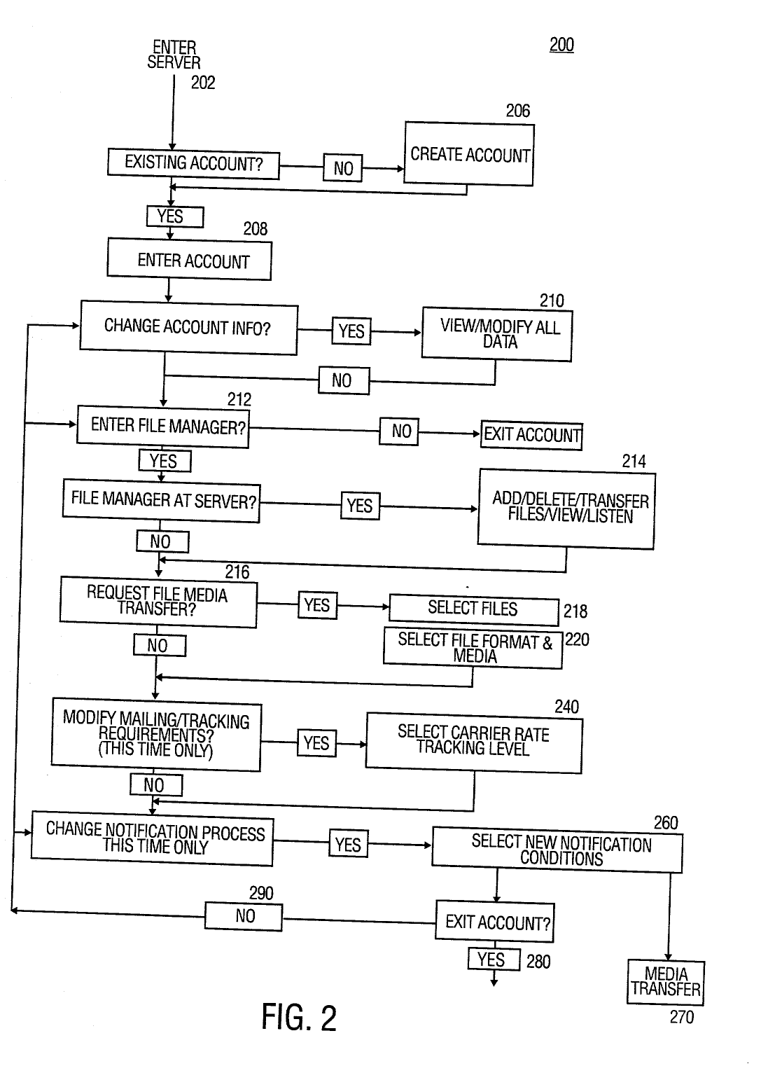

Next, the particular methods of the invention are described in terms of computer software with reference to a series of flow diagrams. The methods constitute computer programs made up of computer-executable instructions illustrated as blocks (acts) 206 until 290 in FIG. 2. Describing the methods by reference to a flow diagram enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result. It will be appreciated that more or fewer processes may be incorporated into the methods illustrated in FIG. 2. (flow diagram) without departing from the scope of the invention and that no particular order is implied by the arrangement of blocks shown and described herein.

FIG. 2 is a flow diagram of one embodiment of a method for a file archive and media transfer system with user notification. Once connected to the server 202, a series of options 200 can be provided. In one embodiment, a first option could be to create a new account 206 or to enter an existing account 208. Creating a new account 206 could involve providing information such as a user name, address, certain default conditions such as mailing instructions, a level of file transfer notification and media transfer notification, and account information such as billing information.

If entering an existing account 208 is selected, software on the server could allow access to the account for review and the possible modification of the account information 210, i.e. change/add credit card numbers, addresses, mailing instructions, etc. If no changes to the account information are to be made, the server can then allow access to a file manager 212 to review or modify any files in archive. The software could allow archived files be selected such that the server could open these files, if graphical, for viewing or if audio, for listening. In addition, new files could be added, existing files transferred to another account, or files deleted from the user's account 214.

Next, the server 202 can direct archived files to be copied to a different media (media transfer) 216. Files selected 218 for media transfer 216 can include graphical files that could be copied to a storage medium such as a CD or a paper print. Software on the server 202 could allow a level of resolution to be selected for each graphical file that is placed in the copied storage medium 220. The resolution for each graphical file could be the level in archived file or a resolution less detailed. The files selected 218 for transfer to a print could be in such formats as a portrait on high quality photographic paper, a poster, Christmas cards, a humorous “Wanted” poster, calendars, a post card, etc. Any audio/music files selected could be placed on one or more CDs and/or tapes and the server could translate the files into any music format, such as MP3, Wave, DVD, etc 220.

Next, the user could be asked if “for this time only” mailing instructions are to be changed from the default. If yes, the user could be prompted to enter new mailing instructions that would apply to this transaction only. The new mailing instructions could include such default changes as to use a different carrier and/or carrier rate, a new level of tracking, and/or a new addressee and/or address 240.

Finally, the level of notification for media transfer or file downloads could be changed from the default, for transactions accomplished for this time only 260. The server could allow a change of method of notification of successful files transferred into the account (i.e. to provide notice to a different device), or for tracking information concerning the mailing of the media transferred files, such as the photographic prints or music/photo CDs. For instance, if default was to send file transfer notification to a pager, the server could allow a change to media transfer notification by an automatic message at his cell phone or cell phone answering service. After this operation, the server 202 can send instructions for the generation of file copies to be transferred to a different media 270 or the server 202 could allow exiting the account 280 or a selection from previous account options 290.

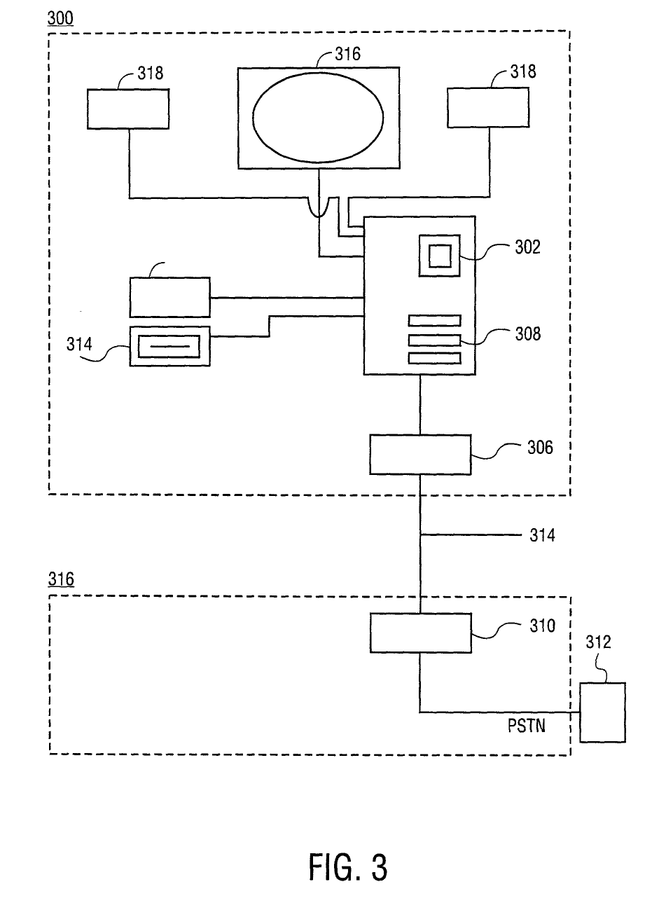

FIG. 3 is an illustration of one embodiment of a method of use of the media transfer system with user notification. In one embodiment, the device might be a photo kiosk 300. The photo kiosk 300 could contain a computer chip (CPU) 302 and a local storage device 304 such as a hard disk drive or a tape drive. A server 310 could be accessed by the photo kiosk 300 to download files. The files provided by a user could be first placed on the hard disk drive 304 or transferred directly to the server 310 from a floppy drive 314 such as a floppy disk, a Zip© disk, flash memory cards, a digital camera, etc. The file transfer between the photo kiosk 300 and the server 310 can use a modem 306 and any available network 314. Alternatively, the photo kiosk 300 could retain the files internally in the hard drive, RAM, or flash memory 308 as buffer for later transfer to the server 310 at a more convenient time. Initially, the photo kiosk 300 could provide review, i.e. allow the user to view or listen to files to downloading. The files can be reviewed form from a user storage medium such as a floppy disk (not shown) inserted into the photo kiosk floppy drive 314. The review could be accomplished using a monitor 316 and/or speakers 318 and 318′ in the photo kiosk 300. The photo kiosk 300 could then allow files to be selected from the floppy disk for transfer. If the files are transferred into the photo kiosk 300, the photo kiosk 300 could connect presently, or at a later time, to the server 310 over PSTN using a connection made with the modem 306 or over a network such as the Internet using DSL. The server 310 could accept files for archive at a time convenient for the server 310 and at a rate dictated by the type of modem 306. This could mean that file transfer to the server 310 may not be complete for a period of time after the initial file download into the photo kiosk 300.

File transfer notification to the user, of successful file download to the server 310, might be desirable prior to the user deleting his original files. In addition, status on events other than file receipt at a server, such as mailing status or billing information, could be provided by the server 310. The mailing status may be of a previous media transfer request. This status could be accomplished through a media transfer notification process, where such media transfer notification could be automatically sent to the photo kiosk 300 from the server 310 or sent as a result of a query from the photo kiosk 300.

The server/website portion 316 of the system could include any file manager capable of meeting the needs of a graphical/music file storage system. In addition, such a file manager should be supported by sufficient storage capacity to maintain the expected number of files in archive for a desired period of time such as one year or even indefinitely. The storage capacity could be increased with the addition of storage devices located remotely 312. Such a system 316 that can meet these requirements for the file manager is Image Station by Sony Electronics, Inc.

The server could charge the account for the transfer of copies of files to a different media such as prints or CDs plus shipping. The user could access billing information as well as other notification data when logged into the account and/or notification data could be provided through the file transfer and/or media transfer notification processes.

The server may allow a first party, who may or may not have an account, to upload one or more files to an account of a second party who may have an account. Such file transfers may require a determination by the receiving party as to the acceptance of the files. The receiving party may have a default to simply accept all file transfers or deny all file transfers into the account. Alternatively, the receiving party may allow the incoming files to be placed in a “buffer” account on the server until individually viewed and/or accepted. If not accepted within a period of time, the buttered files could be deleted by the server.

The archived files could be stored at the storage location (e.g. the server location) on any machine-readable media such as CD ROM, DVD, hard disk drive, floppy disk, tape system, etc. Even though archived, the archived data can be quickly accessed and viewed by a device having display and/or sound capability, such as the photo kiosk or a computer terminal.

A system to archive a potentially large amount of files, to manipulate the file data into a different file format, onto a different medium, to ship the new medium, to be billed for some of the transactions, and to be notified of the completion or status of certain transactions has been disclosed. From the website, the server allows the user to create and enter an account having a variety of options. One option may be to modify existing account information such as credit card numbers or mailing address. The server can allow the user to enter the file manager and add files into the account by downloading from a first device at his location. The server may allow the user to delete files existing within the account or copy files to another account. The server can allow the selection of files for media transfer such as copying graphics files onto a print or CD or music files onto a CD. Options to change the default settings for this one transaction can be provided the user. Media transfer notification data can be set as default with the user prompted for any changes on a one-time basis as well.

The description of FIGS. 1 & 3 are intended to provide one embodiment of computer hardware and other operating components suitable for implementing the invention, but it is not intended to limit the applicable environments. It will be appreciated that the photo kiosk is one example of many possible computer systems that have different architectures and that other types of systems that function in a similar manner are within the scope of the invention.

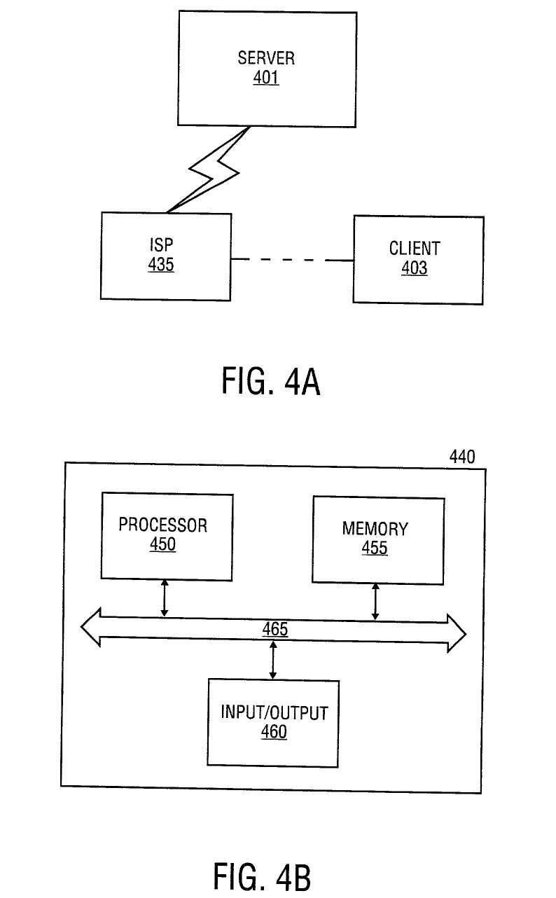

The descriptions in FIGS. 4A & 4B are intended to provide an overview of computer hardware and other operating components suitable for implementing the invention, but it is not intended to limit the applicable environments. FIG. 4A illustrates one embodiment of a networked system of computers such as may be associated with the World Wide Web for example. Server 401 is coupled to ISP (Internet Service Provider) 435 through a network such as the World Wide Web. Client 403 is a client device such as an end-user computer or other end-user terminal, and client 403 is coupled to ISP 435. Thus, communication may be achieved between client 403 and server 401.

FIG. 4B illustrates one embodiment of a machine such as a computer, which may be suitable for implementation of client 403, server 401, or both. Machine 440 includes processor 450, memory 455, input/output 460 and bus 465. Bus 465 is coupled to each of processor 450, memory 455 and input/output 460, allowing communication and control there between.

In the foregoing, the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. The present specification and figures are accordingly to be regarded as illustrative rather than restrictive.

For example, those of ordinary skill within the art will appreciate that where the invention as been described in terms of creating an archive copy of graphic and music files that the files may encompass any format, such as jpeg, tiff, bitmap, DOME, etc. for graphic files and DVD, WAVE, MP3, etc. for music files.

The terminology used in this application with respect to networks is meant to include all of environments in which a server computer communicates with the user devices to send and receive data. Therefore, it is manifestly intended that this invention be limited only by the following claims and equivalents thereof.

What is claimed is:

1. A computerized method, comprising:
receiving from a first device, across one or more networks, one or more files to a storage location; and
providing file transfer notification to a second device, across the one or more networks.

2. The method of claim 1, further comprising:
generating a media transfer request.

3. The method of claim 2, further comprising:
providing media transfer notification to the second device, across the one or more networks.

4. The method of claim 1, wherein the first device is the same as the second device.

5. The method of claim 1, further comprising, a server receiving input from the first device to select one or more files in archive.

6. The method of claim 12, further comprising:
transferring the selected files onto a different media based on input from the first device.

7. The method of claim 6, wherein, the server provides media transfer notification to the first device.

8. The method of claim 6, wherein the server provides media transfer notification to the second device.

9. The method of claim 14, further comprising, tracking a mailing status of the media transferred files.

10. The method of claim 1, wherein the first device is Internet enabled.

11. The method of claim 1, wherein the first device is telephony enabled.

12. The method of claim 1, wherein the first device selected from the group consisting of an ATM, a photo kiosk, a personal computer, a pager, telephone, and an Internet-enabled PDA.

13. The method of claim 1, wherein the second device is telephony enabled.

14. The method of claim 1, wherein the second device is selected from the group consisting of pager, telephone, fax, answering machine and telephony-enabled PDA.

15. The method of claim 1, wherein the second device is a letter delivered by a public mail system.

16. The method of claim 1, wherein the received files are graphic files.

17. The method of claim 1, wherein the received files are audio files.

18. The method of claim 1 wherein one of the one or more networks is the PSTN.

19. The method of claim 1, wherein one of the one or more networks is selected from the group consisting of the Internet, WAN, and LAN.

20. The method of claim 19, wherein VPN is implemented.

21. A computerized system, comprising:
a server, comprising:
a file manager, and
a storage medium, wherein the server connects a first device to an account through one or more networks for file transfer and media transfer requests, and generating media transfer notification and file transfer notification.

22. The system of claim 21, further comprising the server capable of sending to a second device, the media transfer notification and file transfer notification.

23. The system of claim 21, wherein the file manager is an Image Station.

24. The system of claim 21, wherein the first device is Internet-enabled.

25. The system of claim 21, wherein the first device is telephony-enabled.

26. The system of claim 21, wherein one of the one or more networks is PSTN.

27. The system of claim 21, wherein one of the one or more networks is a LAN.

28. The system of claim 21, wherein one of the one or more networks is a WAN.

29. The system of claim 21, where the second device is telephony-enabled.

30. The system of claim 21, where the second device is the same as the first device.

31. An apparatus, comprising:
one or more networks;
means for interacting with a server;
means for receiving media transfer notification, and
means for receiving file transfer notification.

32. The apparatus of claim 31, further comprising:
means for transferring files; and
means for storing files.

33. The apparatus of claim 31, further comprising:
means for obtaining the files in a transferred media.

34. The apparatus of claim 33, further comprising:
means for tracking a mailing status of the transferred media.

35. A machine-readable medium having executable instructions for performing a method, the method comprising:
transferring one or more files across one or more networks;
transferring at least one of the one or more files into a different media;
providing file transfer notification; and
providing media transfer notification.

36. The machine-readable medium of claim 35 having further executable instructions for performing a method, the method further comprising:
transferring the one or more files from the archive to a different media.

37. The machine-readable medium of claim 35 having further executable instructions for performing a method, wherein the media transfer notification confirms a successful file transfer into an archive.

38. A machine-readable medium having executable modules comprising:
a file manager that manages a file archive storage medium;
an accounting system;
a file transfer notification system; and
a media transfer notification system.

39. The machine-readable medium of claim 38 having further executable modules comprising:
the accounting system is modifiable from a first device.

40. The machine-readable medium of claim 38 having further executable modules comprising:
media transfer notification data and file transfer notification data is accessible by a query from the first device.

41. A system, comprising:
a processor;
a memory coupled to the processor through a bus; and
a file archive and media transfer process executed from the memory by the processor to cause the processor to receive from a first device, across one or more networks, one or more files to a storage location and to provide file transfer notification to a second device.

42. The system of claim 41, wherein the file transfer notification of an event selected from the group consisting of successful file transfer, partially successful file transfer, and unsuccessful file transfer.

43. The system of claim 41, further comprising:
one or more files converted to a different media and the different media delivered to an address.

44. The system of claim 43, wherein a media transfer notification is sent to the second device to provide tracking information on a shipment of the files transferred to the different media.

45. The system of claim 41, wherein the first device is the same device as the second device.
